(19) United States
(12) Patent Application Publication
(10) Pub. No.: US 2012/0212446 A1
(43) Pub. Date: Aug. 23, 2012

(54) Touch Control Device

(76) Inventor: Tung-Ming Wu, New Taipei City (TW)

(21) Appl. No.: 13/166,815

(22) Filed: Jun. 23, 2011

(30) Foreign Application Priority Data
Feb. 21, 2011 (TW) 100105607

(51) Int. Cl. G06F 3/045

(52) U.S. Cl. 345/174

(57) ABSTRACT

A touch control device includes a plurality of superimposed touch pads and a logic unit. Each of the touch pads includes a substrate, a plurality of detecting wires disposed on the substrate, and a detecting unit for detecting variations of electric characteristics of the plurality of detecting wires to output a detection result. The logic unit is coupled to the plurality of touch pads, for determining contents of at least a touch event according to the detection result generated by each of the touch pads. Arrangements of arranging the plurality of detecting wires included in each of the touch pads on the substrate are different.

### BACKGROUND OF THE INVENTION

1. Field of the Invention

The present invention relates to a touch control device, and more particularly, to a touch control device having a number of superimposed touch pads.

2. Description of the Prior Art

A touch control device benefits from ease of operation, fast reaction and space efficiency, and enables users to perform operations more intuitively and conveniently, and has become an important input interface, widely utilized in various consumer electronic products. Specifically, a touch control device utilizes a detection circuit to detect electrical signals of a matrix composed of a plurality of wires, and convert the electrical signals into digital detection data values to determine a touch event. However, such a conventional touch control device is only suited for two-dimensional applications, and does not allow different variations of operations.

Furthermore, the conventional touch control device is primarily suited for single point touch operations, and faulty determination may arise for multi-touch applications.

For example, please refer to FIG. 5, which is a schematic diagram of a projected capacitive touch sensing device 50 of the prior art. The projected capacitive touch sensing device 50 includes sensing capacitor strings X₁-Xₘ and Y₁-Yₙ. Each sensing capacitor string is a one-dimensional structure formed by connecting a plurality of sensing capacitors in series. The conventional touch sensing method resorts to detecting the capacitance in each sensing capacitor string to determine whether a touch event occurs. The sensing capacitor strings X₁-Xₘ and Y₁-Yₙ are utilized to determine vertical and horizontal touch events, respectively. In the case of horizontal operations, assume the sensing capacitor string X₁ has Q sensing capacitors, each sensing capacitor with a capacitance of C, then under normal circumstances, the sensing capacitor string X₁ has a capacitance of QC. If a difference in capacitance caused by a human body (e.g. a finger) touching a sensing capacitor of the sensing capacitor string X₁ is ΔC, it can be inferred that the finger is touching a certain point on the sensing capacitor string X₁ when the capacitance of the sensing capacitor string X₁ is detected to be greater than or equal to “QC+ΔC”. However, for multi-touch operations, as shown in FIG. 5, two fingers concurrently touch the projected capacitive touch sensing device 50, and the sensing capacitor strings X₃, Xₘ₋₁, Y₃ and Yₙ₋₁ concurrently sense capacitance variations; thus, it is determined touch events occur at all of points (X₃, Y₃), (X₃, Yₙ₋₁), (Xₘ₋₁, Y₃) and (Xₘ₋₁, Yₙ₋₁). In fact, only (X₃, Y₃) and (Xₘ₋₁, Yₙ₋₁) are real touch points, whereas (X₃, Yₙ₋₁) and (Xₘ₋₁, Y₃) are not. As a result, a faulty determination of the projected capacitive touch sensing device 50 leads to a detection error, in that two nonexistent touch points are registered, and causing what is know as the “ghost key” phenomenon. Therefore, for multi-touch operations, it is only possible to determine which intersections of the sensing capacitor strings the touch event may have occurred at, instead of a precise and definite touch point.

### SUMMARY OF THE INVENTION

Therefore, the present invention primarily provides a touch control device.

The present invention discloses a touch control device, including a plurality of superimposed touch pads, each of the touch pads including a substrate; a plurality of detecting wires, disposed on the substrate; and a detecting unit coupled to the plurality of detecting wires, for detecting variations of electric characteristics of the detecting wires to output a detection result; and a logic unit coupled to the touch pads, for determining contents of at least a touch event according to the detection result generated by each of the touch pads; wherein arrangements of arranging the detecting wires included in each of the touch pads on the substrate are different.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a touch control device according to an embodiment of the present invention.

FIG. 2 is a schematic diagram of an arbitrary touch pad of the touch control device shown in FIG. 1.

FIG. 3 is a bird's eye view perspective diagram of the touch pad shown in FIG. 2.

FIG. 4 is a schematic diagram of the arbitrary touch pad shown in FIG. 2 detecting a touch event.

FIG. 5 is a schematic diagram of a conventional projected capacitive touch sensing device.

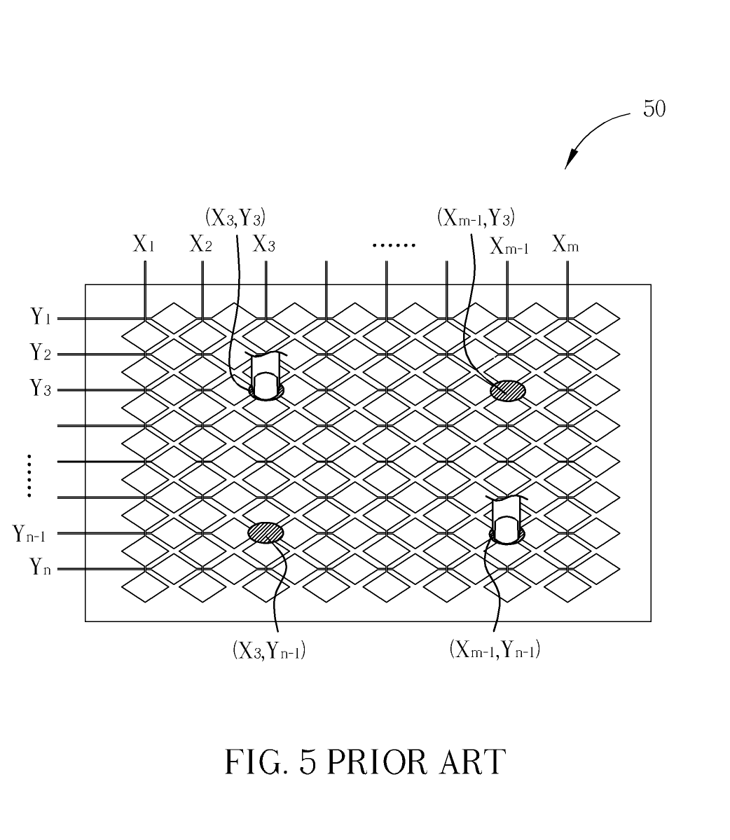

FIG. 6 is a perspective schematic diagram of touch pads of a touch control device according to an embodiment of the present invention.

FIG. 7 is a schematic diagram of the touch control device shown in FIG. 6 applied to multi-touch operations.

FIG. 8 is a perspective schematic diagram of touch pads of a touch control device according to an embodiment of the present invention.

FIG. 9 is a perspective schematic diagram of touch pads of a touch control device according to an embodiment of the present invention.

FIG. 10 is a perspective schematic diagram of touch pads of a touch control device according to an embodiment of the present invention.

### DETAILED DESCRIPTION

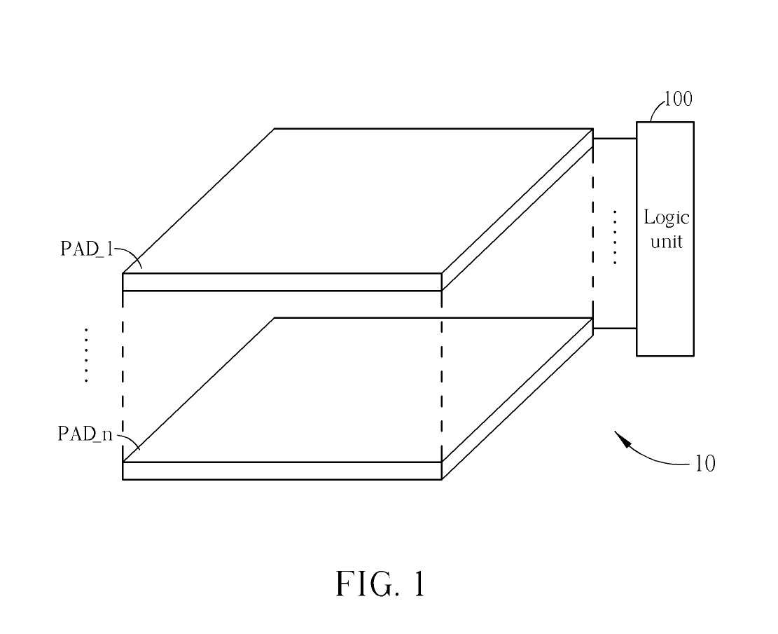

Please refer to FIG. 1, which is a schematic diagram of a touch control device 10 according to an embodiment of the present invention. The touch control device 10 not only detects two-dimensional characteristics of a touch, but also concurrently detects the touch in vertical directions. The touch control device 10 mainly includes touch pads PAD_1-PAD_n and a logic unit 100. The touch pads PAD_1-PAD_n are superimposed on each other through adhesive means, and each of the touch pads is capable of sensing touch status and generating a corresponding touch result. The logic unit 100 determines a content of a touch event according to the touch result generated by the touch pads PAD_1-PAD_n. More specifically, the content of the touch event includes a position and intensity, i.e. three-dimensional characteristics of the touch event.

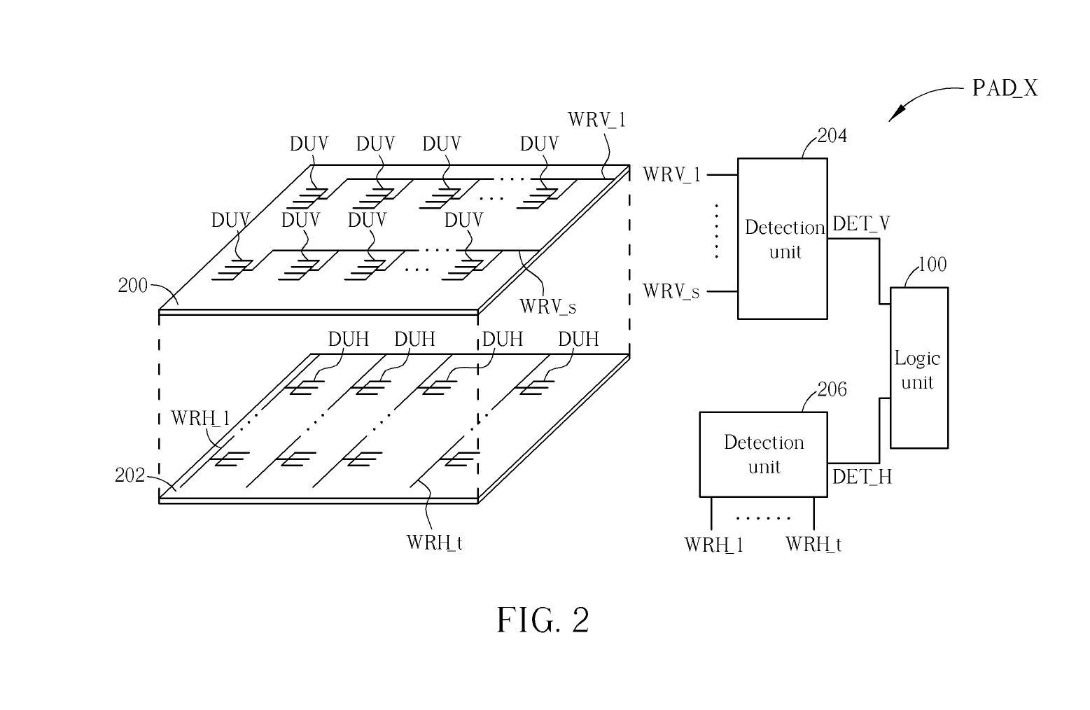

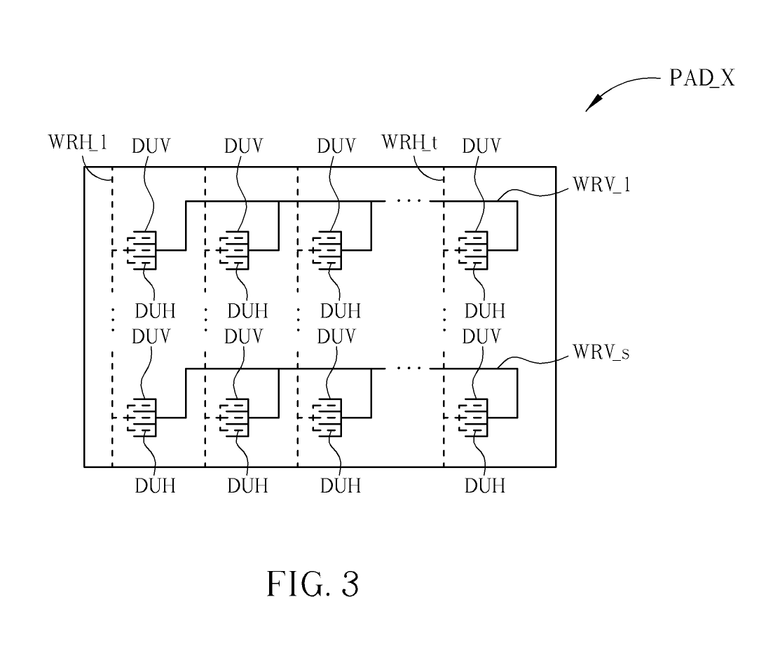

Please refer to FIGS. 2 and 3 for more detail. FIG. 2 is a schematic diagram of an arbitrary touch pad PAD_x of the touch control device 10, and FIG. 3 is a bird's eye view perspective diagram of the touch pad PAD_x. The touch pad PAD_x includes a first substrate 200, a second substrate 202, detecting wires WRV_1-WRV_s, WRH_1-WRH_t, and detecting units 204, 206. As shown in FIGS. 2 and 3, the detecting wires WRV_1-WRV_s are horizontally disposed along a vertical direction on the first substrate 200, with sensing units DUV disposed at fixed distances; the detecting wires WRH_1-WRH_t are vertically disposed along a horizontal direction on the second substrate 202, with sensing units DUH disposed at fixed distances. The sensing units DUV and DUH are disposed at relative positions, as shown in FIG. 3, for detecting touch at a same position. Moreover, the detecting unit 204 is coupled to the detecting wires WRV_1-WRV_s, for detecting variations of electrical characteristics of the detecting wires WRV_1-WRV_s to output a detection result DET_V to the logic unit 100. The detecting unit 206 is coupled to the detecting wires WRH_1-WRH_t, for detecting variations of electrical characteristics of the detecting wires WRH_1-WRH_t to output a detection result DET_H to the logic unit 100. Therefore, the logic unit 100 may determine a vertical position at which the touch event occurs according to the detection result DET_V generated by the detecting unit 204; and the logic unit 100 may determine a horizontal position at which the touch event occurs according to the detection result DET_H generated by the detecting unit 206.

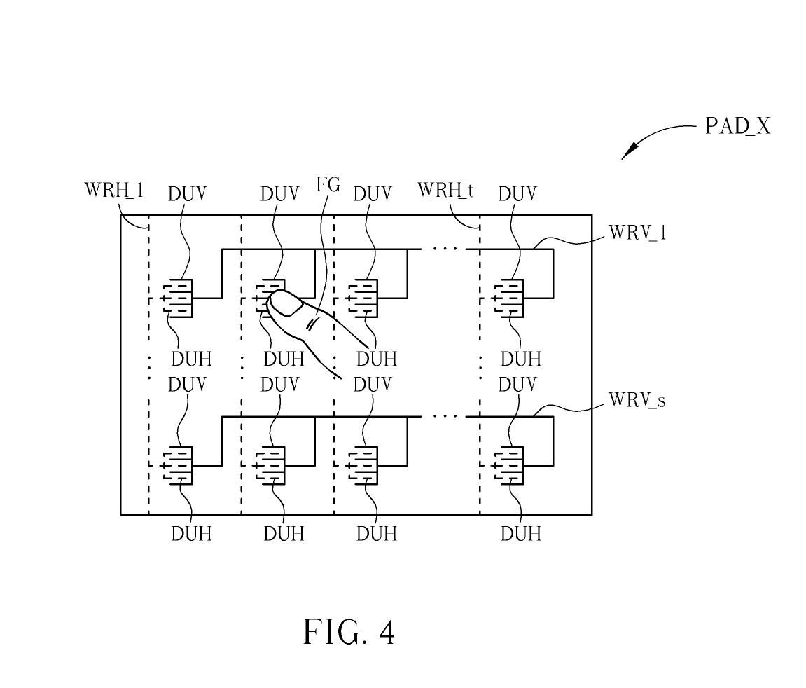

For example, please refer to FIG. 4, which is a schematic diagram of the arbitrary touch pad PAD_x detecting a touch event. As shown in FIG. 4, if a finger touches an intersection between the detecting wires WRV_1 and WRH_2, the detection result DET_V outputted by the detecting unit 204 would indicate electrical signal variations on the detecting wire WRV_1; similarly, the detection result DET_H outputted by the detecting unit 206 would indicate electrical signal variations on the detecting wire WRH_2. Therefore, the logic unit 100 may determine the touch event occurs at a position (2, 1).

Further, the detection results DET_V, DET_H outputted by the detecting units 204, 206 may include an electrical signal intensity, e.g. to detect how a signal intensifies when the finger is closer, and weakens when the finger is further away. As such, the logic unit 100 can determine not only a position of the touch event, but also an intensity of the touch event, i.e. to detect the touch event in three dimensions. Therefore, via superimposing the touch pads PAD_1-PAD_n, the touch control device 10 can detect three-dimensional characteristics of the touch event, thereby enhancing operation variability.

Note that, the essence of the present invention lies in superimposing the touch pads PAD_1-PAD_n to detect three-dimensional characteristics of a touch event, and any variations made accordingly are within the scope of the present invention. For example, despite the first substrate 200 and second substrate 202 being separately depicted in FIG. 2, the two may be two wiring layers within a single double-layered or multi-layered circuit board. Moreover, materials for forming the touch pads PAD_1-PAD_n are not limited; transparent materials may be used for touch display devices. In other words, in the example of FIG. 2, a transparent material is used for the first substrate 200, the second substrate 202, and the detecting wires WRV_1-WRV_s, WRH_1-WRH_t. In addition, the variation of electrical characteristics detected by the touch pads PAD_1-PAD_n may be an electric charge variation, or any other electrical signal capable of indicating characteristics of a touch event.

Furthermore, through suitably adjusting operations of the logic unit 100, the touch control device 10 of the present invention may further be applied in three-dimensional multi-touch operations, thereby further enhancing operation variability.

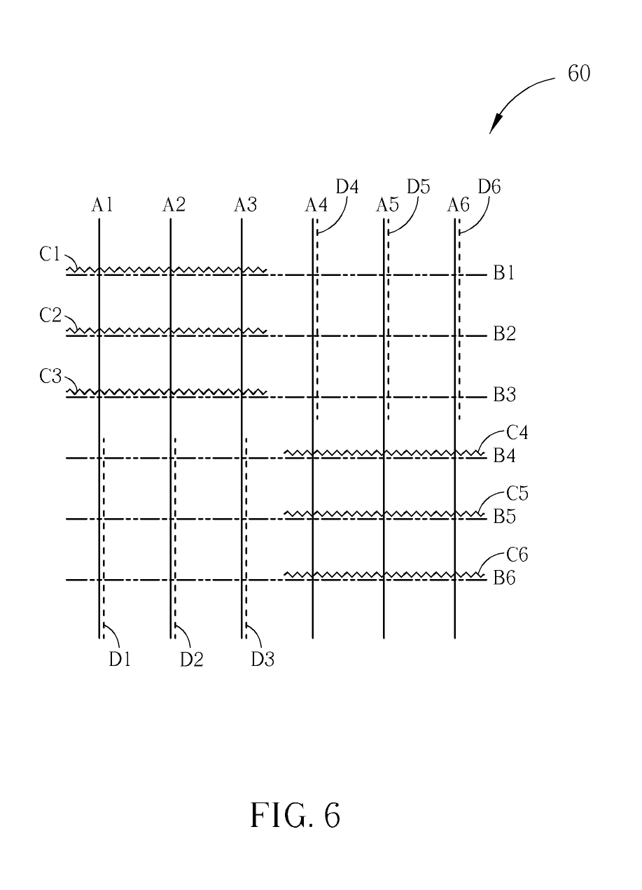

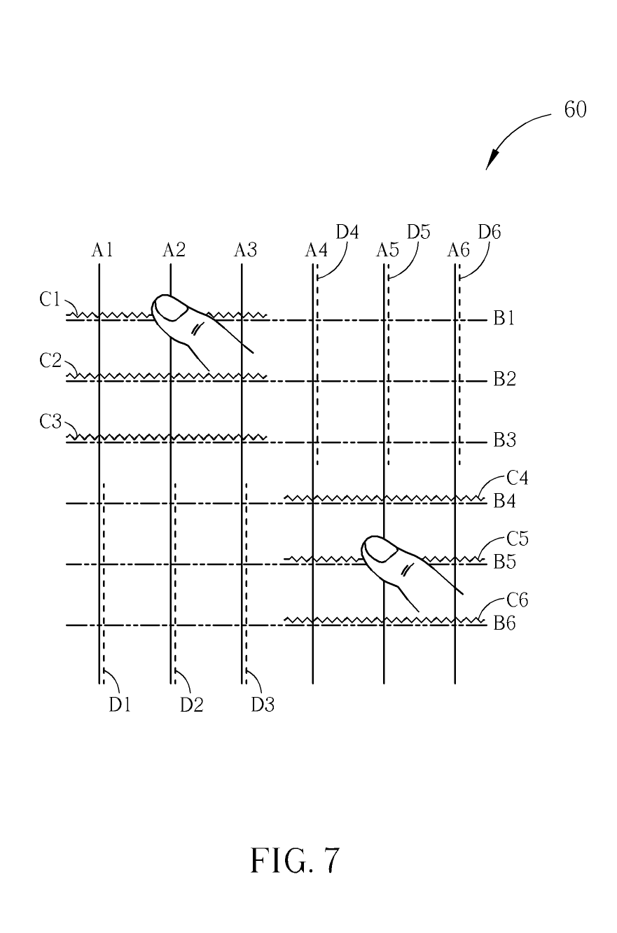

Note that, in the touch control device 10, sizes of the touch pads PAD_1-PAD_n; layout, lengths and quantity of the detecting wires, and quantity of the substrates may all be different. As such, the touch control device 10 may be further applied to multi-touch applications. For example, please refer to FIG. 6 which is a perspective schematic diagram of touch pads of a touch control device 60 according to an embodiment of the present invention. The touch control device 60 has a same structure as that of the touch control device 10, and only a layout of the detecting wires in the touch pads is shown for conciseness. The touch control device 60 includes four layers of touch pads, each touch pad including only a single substrate for disposing the detecting wires, wherein a first layer touch pad is disposed with detecting wires A1-A6, a second layer touch pad is disposed with detecting wires B1-B6, a third layer touch pad is disposed with detecting wires C1-C6, and a fourth layer touch pad is disposed with detecting wires D1-D6. Moreover, as shown in FIG. 6, the detecting wires A1-A6 and B1-B6 cover an entirety of the touch pad, whereas the detecting wires C1-C3 only cover an upper-left corner of the touch pad, the detecting wires C4-C6 only cover a bottom-right corner of the touch pad, the detecting wires D1-D3 touch pads only cover a bottom-left corner of the touch pad, and the detecting wires D4-D6 only cover an upper-right corner of the touch pad. Consequently, as shown in FIG. 7, when a user concurrently touches two points on the touch control device 60, the logic unit may correctly determine that a touch event occurs on the detecting wires A2, B1, C1 and A5, B5, C5 through the partially disposed detecting wires C1-C6, D1-D6, and avoid the “ghost key” problem. In other words, in example of FIG. 7, the “ghost key” would have occurred on the detecting wires A5, B1, D5 and A2, B5, D2, yet such faulty determination is avoided since in this case the detecting wires D5, D2 do not detect a touch.

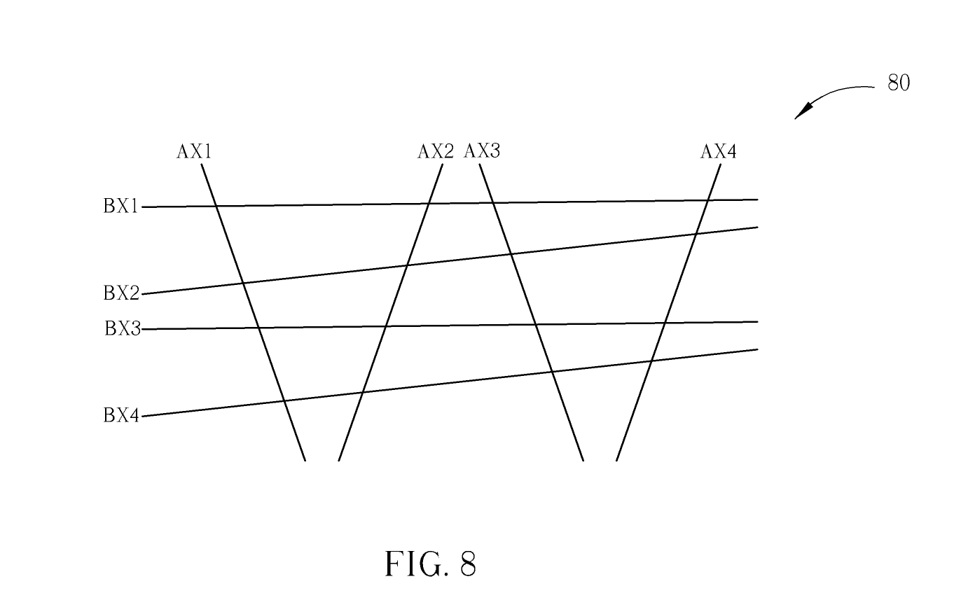

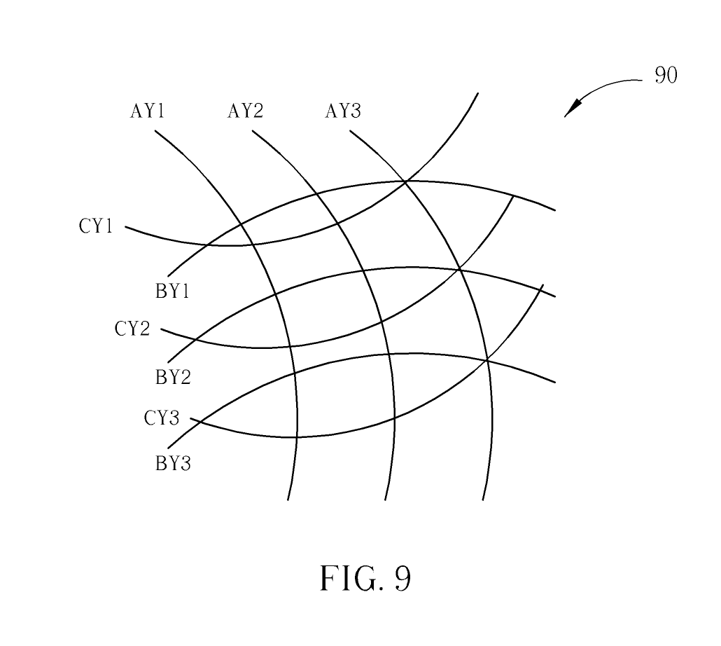

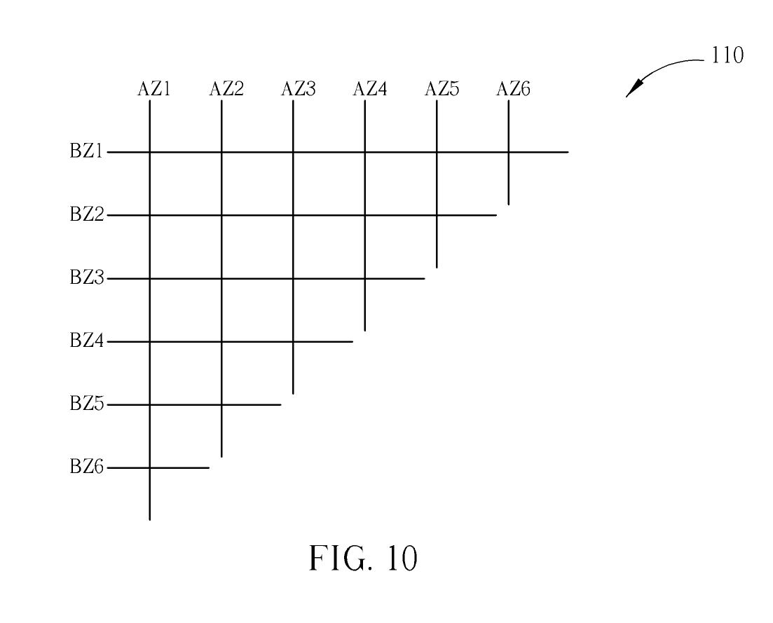

Note that, FIGS. 6 and 7 are used to illustrate that the layout and quantity of the detecting wires in each touch pad in the present invention, as well as the quantity of substrates, etc. may all be modified to suit different application requirements, and are not subject to any limitations. For example, FIG. 8 is a perspective schematic diagram of touch pads of a touch control device 80 according to an embodiment of the present invention. For conciseness, only a layout of the detecting wires of the touch pads is shown. The touch control device 80 includes double-layered touch pads, each touch pad including only a single substrate for disposing the detecting wires; wherein the first touch pad is disposed with detecting wires AX₁-AX4, and the second touch pad is disposed with detecting wires BX₁-BX4. As shown in FIG. 8, the detecting wires AX₁-AX4 are not disposed horizontally to each other, and similarly the detecting wires BX₁-BX4 are not disposed horizontally to each other. Moreover, angles projected by intersections between the detecting wires AX₁-AX4 and the detecting wires BX₁-BX4 are not orthogonal, as is the case in aforementioned embodiments. Additionally, FIG. 9 is a perspective schematic diagram of touch pads of a touch control device 90 according to an embodiment of the present invention, also only showing the layout of the detecting wires of the touch pad. The touch control device 90 includes three-layered touch pads, each touch pad including a single substrate for disposing the detecting wires, wherein the first touch pad is disposed with detecting wires AY1-AY₃, the second touch pad is disposed with detecting wires BY1-BY₃, and the third touch pad is disposed with detecting wires CY1-CY₃. As shown in FIG. 9, the detecting wires AY1-AY₃, BY1-BY₃, CY1-CY₃ are curve-shaped, also suited for the present invention. Additionally, FIG. 10 is a perspective schematic diagram of touch pads of a touch control device 110 according to an embodiment of the present invention, also only showing the layout of the detecting wires of the touch pad. The touch control device 110 includes double-layered touch pads, each touch pad including a single substrate for disposing the detecting wires, wherein the first touch pad is disposed with detecting wires AZ1-AZ6, and the second touch pad is disposed with detecting wires BZ1-BZ6. As shown in FIG. 10, the detecting wires AZ1-AZ6 are of unequal lengths, and the detecting wires BZ1-BZ6 are of unequal lengths, suitable for implementing triangular touch control devices, also suited for the present invention.

Those skilled in the art should understand via the aforementioned embodiments that the layout of the detecting wires in the present invention is not limited, and may be suitably adjusted for different application requirements.

As can be seen from the above, the present invention utilizes superimposed touch pads to detect three-dimensional characteristics of a touch event. Additionally, the present invention may be modified to suit multi-touch applications through adjusting layout or quantity of the detecting wires in each touch pad, to avoid the “ghost key” problem.

In summary, the present invention detects three-dimensional characteristics of a touch event and accommodates multi-touch applications to enhance operation variability.

Those skilled in the art will readily observe that numerous modifications and alterations of the device and method may be made while retaining the teachings of the invention.

What is claimed is:

1. A touch control device, comprising:
a plurality of superimposed touch pads, each of the touch pads comprising:
a substrate;
a plurality of detecting wires, disposed on the substrate; and
a detecting unit coupled to the detecting wires, for detecting variations of electric characteristics of the detecting wires to output a detection result; and
a logic unit coupled to the touch pads, for determining contents of at least a touch event according to the detection result generated by each of the touch pads;
wherein arrangements of arranging the detecting wires comprised in each of the touch pads on the substrate are different.

2. The touch control device of claim 1, wherein the substrate and the detecting wires in each of the touch pads are formed by a transparent material.

3. The touch control device of claim 1, wherein the detecting wires in each of the touch pads comprise a plurality of sensing units.

4. The touch control device of claim 1, wherein the logic unit determines a position and an intensity of the at least a touch event according to the detection result generated by each of the touch pads.

5. The touch control device of claim 4, wherein the arrangements of arranging the detecting wires comprised in the touch pads on the substrate comprise a quantity of the detecting wires and a position of the detecting wires.

6. The touch control device of claim 1, wherein the detecting wires in each of the touch pads are horizontally disposed on the substrate.

7. The touch control device of claim 1, wherein the detecting wires in each of the touch pads are of unequal lengths.
